(19) United States
(12) Patent Application Publication
(10) Pub. No.: US 2002/0049647 A1
(43) Pub. Date: Apr. 25, 2002

(54) Product repairing method and product repairing apparatus

(75) Inventor: Yukio Kitahara, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 09/983,055

(22) Filed: Oct. 23, 2001

(30) Foreign Application Priority Data
Oct. 24, 2000 (JP) 2000-323594

(51) Int. Cl. G06F 17/60

(52) U.S. Cl. 705/26

(57) ABSTRACT

A product repairing community is composed of a manufacturer and a plurality of users. A repair subscribers' site is provided on the Internet and managed by the manufacturer in such a way that any users may access the site by way of the Internet. The repair subscribers' site is provided with a replacement part sales section, a repair reception section, a replacement part procuring section, and an escrow section. The manufacturer is responsible for the management of the replacement parts possessed by the repair subscribers and also the repair subscribers data base containing information on which repair subscribers possess which replacement parts. The manufacturer utilizes the repair subscribers' site for selling replacement parts of which the compulsory storage periods have expired, receiving requests for repairs, buying replacement parts possessed by users and settling the accounts for selling and buying replacement parts.

### BACKGROUND OF THE INVENTION

1. Field of the Invention

The present invention relates to a product repairing method and a product repairing apparatus for controlling the repairs of industrial products. More particularly, the present invention relates to a product repairing method and a product repairing apparatus for procuring parts of a product item after the expiration of the compulsory storage period of replacement parts of the manufacturer for the product item.

2. Description of the Related

The compulsory storage period of replacement parts of the manufacturer is provided by each manufacturer for every industrial product item such as an electric home appliance or an automobile. The period typically extends by certain years beyond the time when the manufacturer terminates the manufacture of product item. After the expiration of the compulsory storage period of replacement parts, the manufacturer no longer stores them and hence any of the users cannot have their products repaired by replacement if their products become defective and inoperative.

Manufacturers do not hold replacement parts beyond the compulsory storage period in consideration of the efficiency of running the business and that of funding. A number of problems may arise if a manufacturer keeps on storing replacement parts beyond the compulsory storage period. Firstly, as the storage period of replacement parts is extended, both the cost of storing replacement parts and that of controlling them will increase. Secondly, since such replacement parts are held as asset, they can obstruct the efforts for running the business effectively and efficiently to meet the current demands particularly in terms of development, manufacture and sales of new products.

However, in recent years and the near future, our mass consumption society has been changing to a circulation type society. Three “Rs”, or “reduce” (reduction of the consumption level of the society), “reuse” (reuse of industrial products) and “recycle” (recycling of raw materials), operate as keywords in a circulation type society. In other words, consumers want to use and cherish each and every industrial product for a prolonged period of time. On the other hand, manufacturers stick to the compulsory storage period of replacement parts and hence no replacement parts are available after the expiration of the compulsory storage period.

### SUMMARY OF THE INVENTION

It is an object of the present invention to provide a product repairing method and a product repairing apparatus adapted for the manufacturer to supply the users with replacement parts for a prolonged period of time without incurring problems that can arise from holding replacement parts for a long time. Obviously, such a method and such a apparatus are desirable in a so-called circulation type society.

According to the present invention, there is provided a product repairing method comprises: receiving a request from a first repair subscriber for repairing a product; selling a replacement part to the first repair subscriber in response to the request, provided that a replacement part necessary for the requested repair is in stock; retrieving second repair subscribers holding the replacement part by means of a computer storing a subscribers data base accumulating information on a plurality of repair subscribers, and procuring the replacement part from one of the second repair subscribers, provided that the replacement part necessary for the requested repair is not in stock; and repairing the product by using the replacement part.

Thus, according to the present invention, it is possible to procure a replacement part for a repair subscriber requesting a repair of a product for which the compulsory storage period of replacement parts has expired from some other subscriber if the manufacturer does not have such a replacement part in stock and hence cannot sell it to the subscriber. Thus, the repair can be done after the expiration of the storage period.

Additionally, if said replacement part necessary for the requested repair is not in stock, with the above-mentioned product repairing method according to the present invention, the procurement of the replacement part from the one of the second repair subscribers may be achieved by receiving deposit of the price of the replacement part from the first repair subscriber, receiving consignment of the replacement part from the second repair subscriber, supplying the replacement part to the first repair subscriber, and paying the price to the second repair subscriber. Thereby, a replacement part can be safely and surely procured between the repair subscribers with this arrangement.

Additionally, if said replacement part necessary for the requested repair is not in stock, with the above-mentioned product repairing method according to the present invention, the procurement of the replacement part from the one of the second repair subscribers may be achieved by disclosing information on the possible procurement of the replacement part to the plurality of second repair subscribers by way of a web site, inputting information on the replacement part to be sold to the web site by any of the plurality of second repair subscribers having an intention of selling the replacement part, selecting one of the second repair subscribers having the intention of selling the repair subscriber, and procuring the replacement part from the selected one of the second repair subscribers. Thereby, a replacement part can be procured promptly from the second repair subscribers with this arrangement.

A product repairing apparatus according to the present invention includes an input/output device connectable to a plurality of repair subscribers, and a memory device storing information on the repair subscribers as a data base. The above-mentioned input/output device having a repair reception section adapted to receive an input of a request for a repair of a product from one of the repair subscribers, a replacement part sales section adapted to input/output information on a possible sale of the replacement part to the requesting repair subscriber provided that the replacement part necessary for the requested repair is in stock, and a replacement part procuring section adapted to input/output information on a procurement of the replacement part from any of the repair subscribers other than the repair subscriber requesting the repair provided that the replacement part is not in stock.

The input/output device may have an escrow section adapted to receive consignment information of the replacement part input by the repair subscribers having an intention of selling the replacement part and also to receive deposit information of a price of the replacement part input by the requesting repair subscriber in order to realize the sale/purchase of the replacement part between the repair subscribers.

### BRIEF DESCRIPTION OF THE DRAWINGS

FIG. 1 is a schematic block diagram of a product repairing community in an embodiment of the present invention.

FIG. 2 is a schematic block diagram of a product repairing community in the embodiment of the present invention, illustrating one example of the process of repairing a product.

### DETAILED DESCRIPTION OF THE PREFERRED EMBODIMENT

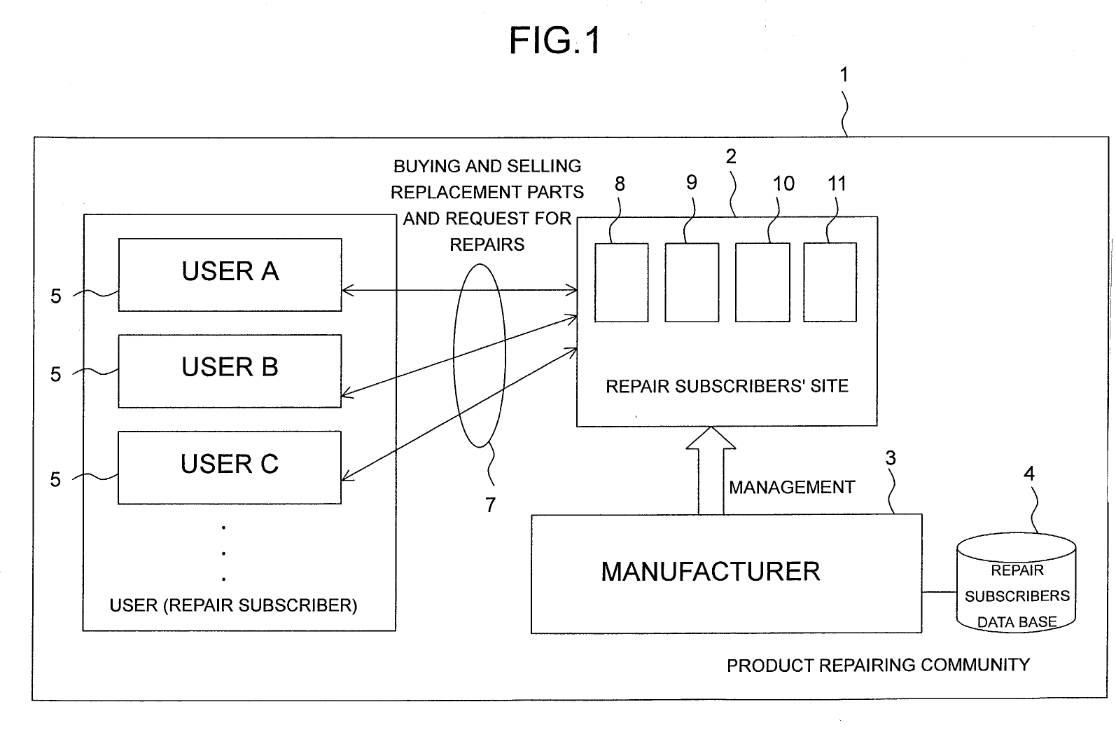

Now, the present invention will be described by referring to the accompanying drawings that illustrate a preferred embodiment of the invention. FIG. 1 is a schematic block diagram of a product repairing community in an embodiment of the invention. As shown in FIG. 1, the product repairing community 1 has as members a manufacturer 3 of products and a plurality of users 5 (user A, user B, user C, . . . ) who are subscribers for repairs. The users 5 may include individual users, repair factories and wholesalers of replacement parts. A repair subscribers' site 2 is provided on the Internet for the product repairing community 1 to mutually connect itself to the users 5 by way of network 7. A repair subscribers data base 4 for managing information on the users 5, who are repair subscribers, by the manufacturer 3 is also provided. The manufacturer 3 provides services of repairing products to the users 5 by way of the repair subscribers' site 2. Thus, this embodiment of product repairing apparatus is composed of the repair subscribers data base 4 and the repair subscribers' site 2.

The repair subscribers' site 2 is provided with a replacement part sales section 8, a repair reception section 9, a replacement part procuring section 10 and an escrow section 11. The replacement part sales section 8 sells replacement parts to any of the users 5 who are repair subscribers for the products they have. The repair reception section 9 receives a request for repairing the product of a user 5 and reads information on a replacement part necessary for the repair from the repair subscribers data base 4. The replacement part procuring section 10 procures a replacement part necessary for the repair from a subscriber other than the subscriber (user 5) requesting the repair. The escrow section 11 receives consignment of the replacement part from the repair subscriber who has an intention of selling and also receives deposit of the price of the replacement part from the requesting repair subscriber when the sale/purchase of such a replacement part is realized between the subscribers.

The manufacturer 3 is responsible for the management of the repair subscribers' site 2 and performs business operations (1) through (4) listed below by way of the repair subscribers' site 2.

(1) Sale of replacement parts for parts out of the compulsory storage period

The manufacturer 3 discloses information on the replacement parts in stock for the products whose parts are out of the compulsory storage period to the users 5 who are repair subscribers by way of the replacement part sales section 8 of the repair subscribers' site 2 and sells replacement parts to any of the users 5.

(2) Reception of requests for repairs

The manufacturer 3 receives requests for repairing products from any of the users 5 by way of the repair reception section 9 of the repair subscribers' site 2. If the user 5 who wants to have his or her product repaired and possesses a replacement part necessary for the repair, he or she will request the manufacturer 3 to repair the product by using the replacement part. If, on the other hand, the user 5 does not possess a replacement part necessary for the repair, he or she will request the manufacturer 3 to procure a replacement part necessary for the repair and repair the product. If the manufacturer 3 possesses a replacement part, it sells the replacement part to the user 5 by way of the replacement part sales section 8.

(3) Purchase of replacement parts possessed by users

If the user 5 requesting the manufacturer 3 to repair his or her product does not possess a replacement part necessary for the repair and the manufacturer 3 does not possess a replacement part either because the compulsory storage period of the part has expired or for some other reason, the manufacturer 3 retrieves repair subscribers who possess such replacement parts by way of the repair subscribers data base 4. Then, the manufacturer 3 purchases a replacement part from one of the repair subscribers, i.e., users 5 having such replacement parts by way of the replacement part procuring section 10 of the repair subscribers' site 2.

(4) Reception of an escrow for the replacement part and the cost

When a replacement part is sold by a user 5 and bought by another user 5 who are equally repair subscribers, the manufacturer 3 receives a consignment note from the user who wants to sell the replacement part and a deposit from the user who wants to buy the replacement part for the possible charge for the replacement part. Then, the manufacturer 3 temporarily holds the consignment note and the deposit. Subsequently, the manufacturer 3 pays the price to the seller and supplies the buyer with the replacement part.

On the other hand, the users 5 can obtain various services including those described above from the manufacturer 3 by way of the repair subscribers' site 2.

The repair subscribers' site 2 is realized by means of the Internet or web technologies employing computer apparatus and adapted to provide the manufacturer 3 with various supports for the business of the manufacturer 3. The repair subscribers' site 2 is adapted to communicate with the user terminals by way of the Internet or some other network 7 and provide the users 5 who are repair subscribers with various services by way of the web browser of the repair subscribers' site 2. Thus, the users 5 can utilize various services provided by the manufacturer 3 by way of the web browser of the repair subscribers' site 2.

More specifically, the manufacturer 3 searches, displays and sells its own replacement parts for each of its product item by way of the web browser of the repair subscribers' site 2. The manufacturer 3 also searches, displays and sells replacement parts possessed by users 5 who want to sell them also by way of the web browser of the repair subscribers' site 2 and receives requests for repairing products whose parts are out of the compulsory storage period. With this arrangement, the users 5 who are repair subscribers can put requests for repairing products and sell and buy replacement parts by way of the web browser of the repair subscribers' site 2.

Additionally, pieces of information on the transactions conducted by way of the repair subscribers' site 2 are accumulated in the repair subscribers data base 4. The information accumulated in the repair subscribers data base 4 include the category of each subscriber, which may be individual or corporate, the code of each replacement part that is sold and bought, the number and the price per part of the replacement parts that are sold and brought in each transaction where replacement parts were sold and bought in the past, the data of each transaction, the attribute information of each subscriber including the address, the name and the telephone number of the subscriber and so on.

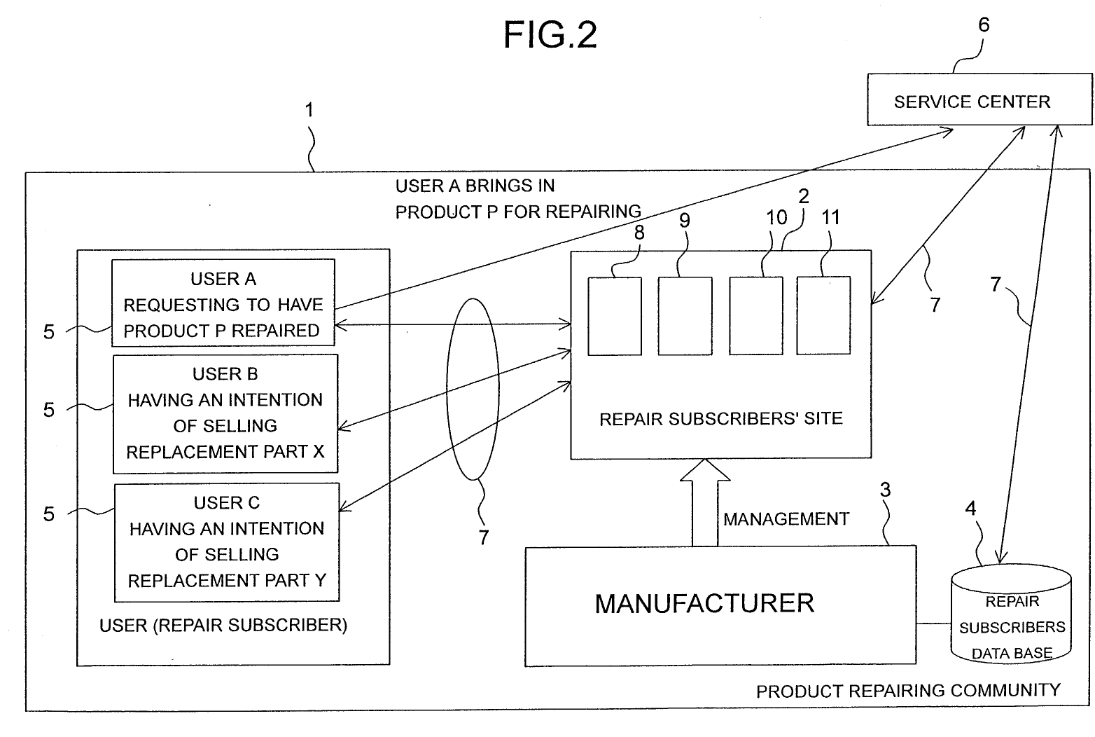

A service center 6 (see FIG. 2) operating for providing product repairing services for the manufacturer 3 may be provided outside the product repairing community 1 so that any users 5 may bring in one or more than one products he or she wants to be repaired. Then, the user 5 can utilize either the repair subscribers' site 2 or the service center 6 when he or she wants to have the manufacturer 3 repair his or her product(s). Additionally, such a service center 6 provides an advantage of receiving a product for which the user 5 does not know what replacement part is necessary.

The service center 6 checks the product brought in by the user 5 and determines the replacement part it needs. If the manufacturer 3 possesses a replacement part for the necessary repair, the service center 6 requests the manufacturer 3 to sell the replacement part to the user 5 by way of the replacement part sales section 8. If the compulsory storage period of the replacement part has expired and the manufacturer 3 does not possess any replacement part for repairing the product, the service center searches for users 5 who possess and can sell such a replacement part by checking the repair subscribers data base 4. Additionally, the service center 6 shows information including the code, the number and the desired price zone per part of replacement parts that are necessary for the possible repair by way of the repair subscribers' site 2 in order to encourage the repair subscribers to sell replacement parts good for the repair. The service center 6 may alternatively be provided in the organization of the manufacturer 3.

Now, how services are provided by the product repairing community will be described below. FIG. 2 is a schematic block diagram of a product repairing community in an embodiment of the invention, illustrating one example of the process of repairing a product. Note that, in FIG. 2, the components that are same as or similar to those of FIG. 1 are denoted respectively by the same reference symbols. In the example shown in FIG. 2, user A, who is one of the users 5, or the repair subscribers, wants to have his or her product P repaired by the manufacturer 3, while user B and user C respectively possess a replacement part X and a replacement part Y that they have bought from the manufacturer 3. The compulsory storage period of replacement parts for the product P has expired and the manufacturer 3 does not possess any replacement parts X and Y.

As shown in FIG. 2, firstly the user A brings the product P into the service center 6 and request to have it repaired. Then, the service center 6 checks the product P and finds that both the part X and the part Y need to be replaced in order to repair the product P. The service center 6 also tells the user A that the manufacturer 3 has already terminated manufacturing products P and that the compulsory storage period of replacement parts for the product has expired and the manufacturer 3 no longer possesses replacement parts X and Y in stock. Under these circumstances, the user A may procure the replacement parts X and Y by way of the repair subscribers' site 2 by itself or, if it is notified by the service center 6 of the fact that the possible repair requires high technological skills, the user A may request the service center 6 to procure replacement parts X and Y and repair the product P, setting an upper limit for the expense of the possible repair.

When the user A procures replacement parts X and Y by way of the repair subscribers' site 2, the user A carries out a transaction for the replacement parts with other users 5 (e. g., the users B and C). To complete the transaction, the escrow section 11 receives the deposit of the prices of the replacement parts X and Y from the user A and the consignments of the replacement parts X and Y from the users B and C. Then, the service center 6 keeps the deposit of the prices of the replacement parts from the user A and the replacement parts X and Y from the users B and C. Thereafter, the service center 6 supplies the user A with the replacement parts X and Y and pays the prices of the replacement parts X and Y to the users B and C respectively.

When, on the other hand, the user A requests the service center 6 to procure replacement parts X and Y and repair the product P, the service center 6 searches the repair subscribers data base 4. Since the repair subscribers data base 4 stores the records of the past transactions of the repair subscribers, the service center 6 can find out if the users B and C have bought the replacement parts X and Y, respectively. Then, the service center 6 asks the users B and C to provide the respective replacement parts X and Y typically by calling the latter or by the replacement part procuring section 10. If possible, the service center 6 procures the replacement parts X and Y at respective prices that may not make the total expense of the possible repair exceed the upper limit set by the user A.

If the service center 6 succeeds in procuring the replacement parts X and Y respectively from the users B and C, it updates the information in the repair subscribers data base 4 so that the data base 4 may reflect the success of procurement. If, on the other hand, the service center 6 does not succeed in procuring the replacement parts X and Y probably because the prices provide an insurmountable barrier, it also updates the information in the repair subscribers data base 4 so that the data base 4 may reflect the failure of procurement and searches for some other repair subscribers who possess replacement parts X and Y.

When it is found that the service center 6 can procure replacement parts X and Y, it actually procures replacement parts X and Y from the users B and C, who are repair subscribers, and settle the accounts for the replacement parts X and Y. Thereafter, the service center 6 repairs the product P of the user A, using the replacement parts X and Y it has procured and charges the user A the cost of the repair including the cost of procurement of the replacement parts X and Y and the charge for the repair work.

As described above, with this embodiment, it is now possible to organize an Internet-based cyber-community (product repairing community 1) for repairing products, in which a manufacturer 3 and users 5 can participate in distributing replacement parts so that any products provided by the manufacturer 3 may be repaired by using replacement parts after the expiration of the compulsory storage period of the replacement parts without raising the cost of storing replacement parts on the part of the manufacturer 3. Then, the manufacturer 3 is not forced to bear the cost of storing replacement parts after the expiration of the compulsory storage period and can reduce the cost of disposing the remaining replacement parts as waste.

Additionally, with this embodiment, it is now possible to remarkably improve the consumer satisfaction (CS) because any product can be repaired after the expiration of the compulsory storage period of replacement parts for the product. Still additionally, with this embodiment, since users 5 who purchased replacement parts can sell them to the manufacturer 3 or some other users 5, the users 5 holding the replacement parts are also relieved of the problem of securely storing the replacement parts if they will not use them in the foreseeable future. Furthermore, with this embodiment, since escrow services are provided to the users 5 for selling and buying replacement parts among them, the users 5 are relieved of the efforts they otherwise have to pay when selling or buying replacement parts.

Thus, according to the present invention, it is now possible to extend the effective storage period of replacement parts without raising the cost of storing them on the part of the manufacturer so that the needs of the consumers who want to comfortably cherish the products of the manufacturer for a prolonged period of time can be satisfied.

What is claimed is:

1. A product repairing method comprising the steps of:
receiving a request from a first repair subscriber for repairing a product;
selling a replacement part to said first repair subscriber in response to the request, provided that the replacement part necessary for said requested repair is in stock;
retrieving second repair subscribers holding said replacement part by means of a computer storing a subscribers data base accumulating information on a plurality of repair subscribers, and procuring said replacement part from one of the second repair subscribers, provided that said replacement part necessary for the requested repair is not in stock; and
repairing said product by using said replacement part.

2. The product repairing method according to claim 1, wherein, if said replacement part necessary for the requested repair is not in stock, the step of procuring said replacement part from said one of the second repair subscribers includes the steps of:
receiving deposit of the price of said replacement part from said first repair subscriber;
receiving consignment of said replacement part from said second repair subscriber;
supplying said replacement part to said first repair subscriber; and
paying the price to said second repair subscriber.

3. The product repairing method according to claim 1, wherein, if said replacement part necessary for the requested repair is not in stock, the step of procuring said replacement part from said one of the second repair subscribers includes the steps of:
disclosing information on the possible procurement of said replacement part to said plurality of second repair subscribers by way of a web site;
inputting information on the replacement part to be sold to said web site by any of said plurality of second repair subscribers having an intention of selling the replacement part;
selecting one of said second repair subscribers having the intention of selling the repair subscriber; and
procuring the replacement part from the selected one of said second repair subscribers.

4. The product repairing method according to claim 3, wherein said information on the replacement part to be sold includes a suggested price at which said replacement part is to be sold and said one of said second repair subscribers is selected when the input suggested price does not exceed an upper limit set by said first repair subscriber and is the lowest among the suggested prices input by said second repair subscribers.

5. The product repairing method according to claim 1, wherein said request from said first repair subscriber for repairing the product is received by way of a web site.

6. The method according to claim 1, wherein said replacement part is sold to said first repair subscriber by way of a web site.

7. A product repairing apparatus comprising:
an input/output device connectable to a plurality of repair subscribers, said input/output device having:
a repair reception section adapted to receive an input of a request for a repair of a product from one of said repair subscribers;
a replacement part sales section adapted to input/output information on a possible sale of the replacement part to the requesting repair subscriber provided that the replacement part necessary for the requested repair is in stock; and
a replacement part procuring section adapted to input/output information on a procurement of the replacement part from any of the repair subscribers other than the repair subscriber requesting the repair provided that the replacement part is not in stock; and
a memory device storing information on said repair subscribers as a data base.

8. The product repairing apparatus according to claim 7, wherein said input/output device has an escrow section adapted to receive consignment information of said replacement part input by said repair subscribers having an intention of selling the replacement part and also to receive deposit information of a price of said replacement part input by said requesting repair subscriber in order to realize the sale/purchase of the replacement part between said repair subscribers.
